(19) United States
(12) Patent Application Publication
(10) Pub. No.: US 2017/0315875 A1
(43) Pub. Date: Nov. 2, 2017

(54) NAMESPACE POLICY BASED DEDUPLICATION INDEXES

(71) Applicant: NetApp, Inc., Sunnyvale, CA (US)

(72) Inventors: Sudhindra Prasad Tirupati Nagaraj, Sunnyvale, CA (US); Pramodh Pisupati, Sunnyvale, CA (US); Gregory Thomas Taleck, Bellevue, WA (US)

(21) Appl. No.: 15/143,133

(22) Filed: Apr. 29, 2016

(51) Int. Cl. G06F 11/14; G06F 17/30

(52) U.S. Cl. CPC G06F 11/1453; G06F 17/30336; G06F 17/30371; G06F 11/1451; G06F 11/1464; G06F 2201/82

(57) ABSTRACT

A cloud storage gateway device can be used to deduplicate data across different namespaces while complying with SLOs that govern data of the different namespaces. A cloud storage gateway device can use multiple fingerprint indexes to comply with different SLOs. Each fingerprint index corresponds to a different SLO. Thus, the cloud storage gateway device deduplicates data against other data governed by a same SLO. Assuming an SLO aligns or indicates a cloud storage target, the cloud storage gateway device will deduplicate data against other data that will eventually migrate from the device to a same cloud storage target. The cloud storage gateway device ensures satisfaction of the governing SLO(s) from receipt of data, through deduplication, to the migration of the data to a cloud storage target.

### BACKGROUND

The disclosure relates generally to the field of data processing, and more particularly to deduplication and service level objectives.

To increase efficient use of storage capacity, storage applications provide for deduplication of data. A deduplication process identifies data blocks in different files with duplicate content, maintains one of the data blocks, and updates metadata of the files to reference the data block. Identification of duplicate data involves generating a value based upon content of a data block. This value is sometimes referred to as a data fingerprint. Cryptographic hash functions are commonly used to generate a data fingerprint (“fingerprint”). Fingerprints are captured in and accessed with a data structure or combination of data structures (e.g., a bloom filter, a cuckoo filter, parallel arrays, etc.). The data structure(s) is referred to as a fingerprint index. Each entry of a fingerprint index indicates a fingerprint and a reference to locate the maintained data block.

### BRIEF DESCRIPTION OF THE DRAWINGS

Aspects of the disclosure may be better understood by referencing the accompanying drawings.

FIG. 1 provides a conceptual block diagram depicting a cloud storage gateway device deduplicating with multiple fingerprint indexes to comply with different SLOs of different namespaces.

FIG. 2 provides a flowchart diagram illustrating example operations for deduplicating data received at a cloud storage gateway device against one or more of multiple deduplication indexes in accordance with one or more SLOs associated with a namespace of the dataset.

FIG. 3 provides a flowchart diagram illustrating example operations for evicting deduplication index entries.

FIG. 4 depicts an example gateway device with a namespace policy based data deduplicator

### DESCRIPTION

The description that follows includes example systems, methods, techniques, and program flows that embody aspects of the disclosure. However, it is understood that this disclosure may be practiced without these specific details. For instance, this disclosure refers to migrating data intelligently across a cloud storage gateway device in accordance with namespace customized SLOs in illustrative examples. But aspects of this disclosure can be applied to deduplicating data of different namespaces to different cloud storage targets without use of SLOs. In other instances, well-known instruction instances, protocols, structures, and techniques have not been shown in detail in order not to obfuscate the description.

### Introduction

For some storage applications, an organization may request that data in different namespaces be isolated from each other. A research and development (“R&D”) department of an organization, for example, may wish to have its data isolated from other departments with less stringent security protocols to avoid risk of data leak into their less secure systems. Accordingly, the organization will typically configure different namespaces on different systems to isolate data of different departments. For instance, a group of servers and data repositories can be assigned for exclusive use by the R&D department, while another group of servers and data repositories are shared by the marketing and human resources departments. The organization can configure policies that indicate different security related service level objectives (SLOs) of the different departments. If the organization's data is stored into cloud storage, the organization may use different storage appliances or cloud storage gateway devices for the different departments to conform to the security restrictions.

Overview

A cloud storage gateway device can be used to deduplicate data across different namespaces while complying with SLOs that govern data of the different namespaces. A cloud storage gateway device can use multiple fingerprint indexes to comply with different SLOs. Each fingerprint index corresponds to a different SLO. Thus, the cloud storage gateway device deduplicates data against other data governed by a same SLO. Assuming an SLO aligns or indicates a cloud storage target, the cloud storage gateway device will deduplicate data against other data that will eventually migrate from the device to a same cloud storage target. The cloud storage gateway device ensures satisfaction of the governing SLO(s) from receipt of data, through deduplication, to the migration of the data to a cloud storage target.

Example Illustrations

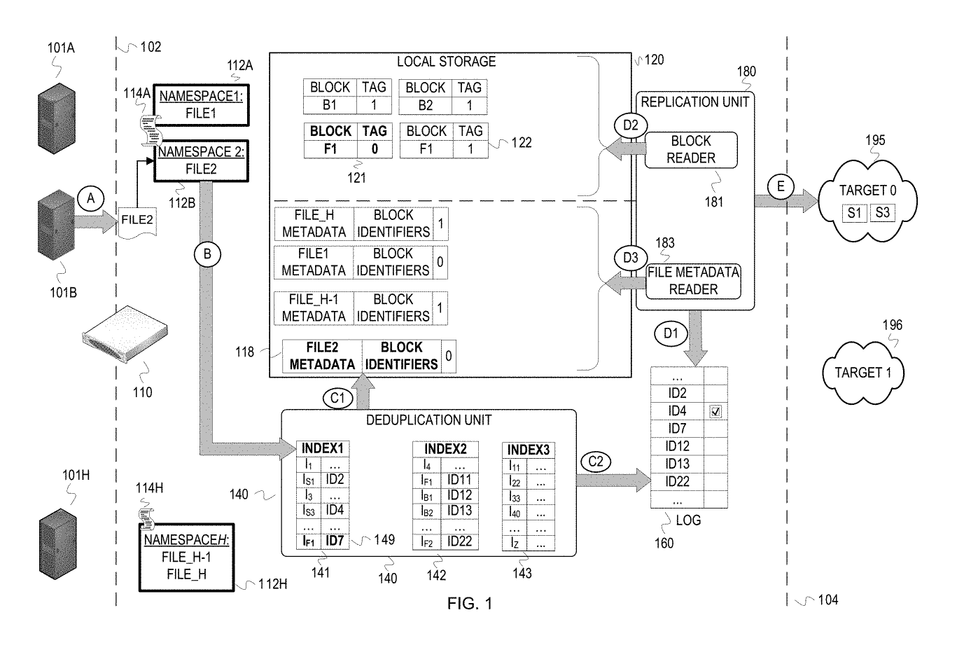

FIG. 1 provides a conceptual block diagram depicting a cloud storage gateway device deduplicating with multiple fingerprint indexes to comply with different SLOs of different namespaces. A cloud storage gateway device 110 receives data from clients 101A-101H for backup to cloud storage. FIG. 1 includes a dashed line 102 and a dashed line 104. These dashed lines 102, 104 delineate the boundaries of the gateway device 110. The elements of FIG. 1 between these dashed lines 102, 104 exist on the gateway device 110. The backup data of the clients 101A-101H are stored to corresponding namespaces configured on the device 110. A namespace can be a sub-space of another namespace. For example, a namespace can be defined by a directory “grp1/” and the sub-directory “grp1/hr” can be referred to as a namespace or sub-space of a namespace (“sub-space”). The cloud storage gateway device 110 comprises a local storage 120, a deduplication unit 140, and a replication unit 180. When evaluating a file for deduplication, the deduplication unit 140 selects from a plurality of fingerprint indexes 141, 142, 143 according to an SLO specified for the file and/or specified for a namespace of the file. The cloud storage gateway device 110 tags deduplicated data blocks and file metadata blocks to indicate a cloud storage target corresponding to the SLO for the replication unit 180 to use.

FIG. 1 is annotated with a series of letters A-E. These letters represent stages of operations. Each stage of operation may comprise one or multiple operations. The stages are not necessarily exclusive and can overlap. Although these stages are ordered for this example, the stages illustrate one example to aid in understanding this disclosure and should not be used to limit the claims. Subject matter falling within the scope of the claims can vary with respect to the order and some of the operations.

A backup application writes data of clients 101A-101H, such as data files FILE 1 to FILE H, to device 110 for backup. Transfer of data for backup may be triggered either by appliance 110 requesting backup of data residing on clients 101A-101H or by backup applications of the clients 101A-101H initiating backup procedures independently. Data from different clients can be written into different namespace or a same namespace depending upon configurations at the client and at the gateway device 110. In addition, the namespaces can correspond to one filesystem or multiple, different filesystems. In Stage A, a FILE2 of a client 101B is written to namespace 112B, identified as NAMESPACE2, configured on the gateway device 110. The namespaces may have been previously exported or remotely mounted to the gateway device 110. By the time Stage A occurs, a file FILE1 has already been written to a namespace 112A, identified as NAMESPACE1, on the gateway device. Files FILE_H-1 and FILE_H have been written to a namespace 112H on the gateway device 110. The namespace 112H is identified as NAMESPACEH in FIG. 1. A service level objective 114A governs the namespaces 112A-112B. This SLO 114A can be defined in a quality of service policy that expresses multiple SLOs for the namespaces 112A-112B. Although a single SLO is depicted, there may be multiple instances of the SLO 114A expressed in different policies. A SLO 114H governs the namespace 112H. Mappings of clients to namespaces may be one-to-many depending upon configuration.

In Stages B and C1-C2, deduplication unit 140 deduplicates the file FILE2 from the namespace 112B with the fingerprint index 141. Stage B represents the deduplication unit 140 selecting the fingerprint index 141 from the multiple fingerprint indexes 141, 142, 143 based on the SLO 114A and deduplicating FILE2 using the fingerprint index 141. For this illustration, the SLO 114A indicates that data can be deduplicated across available namespaces. Available namespaces are those namespaces subject to the SLO 114A in this illustration. This means that the deduplication unit 140 can deduplicate data of the namespaces 112A, 112B, which may increase the amount of storage space saved by deduplication. In contrast, the SLO 114H indicates that data of the namespace 112H can only be deduplicated within the namespace 112H. This may be to satisfy a security policy that isolates the namespace 112H from other namespaces to avoid data leak, for example.

Stages C1-C2 represent the deduplication unit 140 updating the local storage 120 and a log 160 based on deduplication. Stage C1 represents the deduplication unit 140 updating file metadata block 118 of FILE2 to identify constituent data blocks. FIG. 1 depicts the metadata block 118 as including “FILE2 METADATA” and “BLOCK IDENTIFIERS.” The FILE2 METADATA comprises metadata of FILE2 that can include file size, permissions, file type, originating path, etc. The metadata BLOCK IDENTIFIERS includes identifiers of the blocks that constitute FILE2. The deduplication unit 140 will also update the file metadata block 118 with an indication of the appropriate cloud storage target based on the SLO 114A. Although depicted as a single structure, this information can be maintained in multiple data structures with pointers between them. If no matching entry is found in the fingerprint index 140 for a data block (“non-duplicate data block”) of FILE2, the deduplication unit will add an entry for the non-duplicate data block to the fingerprint index 140. When the deduplication unit 140 writes a non-duplicate data block to the local storage 120, the deduplication unit 140 will tag the non-duplicate data block. For instance, the deduplication unit 140 does not find a matching entry in the fingerprint index 140 for the fingerprint for a data block F1 of FILE2. The illustrative value “F1” for the data block represents content of the data block. The deduplication unit 140 inserts an entry 149 into the index 140 since no matching fingerprint was found for F1. The entry 149 includes a fingerprint I_{F1} and the logical block identifier “ID7.” The deduplication unit 140 or a different process (e.g., operating system process, storage subsystem process, etc.) can use a universally unique identifier (UUID) generator. A UUID, sometimes referred to as a globally unique identifier (GUID), is not necessarily unique but should be a unique identifier. A UUID generator can generate an identifier based on a timestamp of the block being named (e.g., creation time), can generate an identifier from a random number generator, can generate an identifier from a combination of values (e.g., a checksum and timestamp, hash value of data block content and medium access control (MAC) address of data source, etc.). The deduplication unit 140 then writes the data block F1 identified as ID7 into the local storage 120 with a tag “0”, resulting in a tagged data block 121. The tag “0” identifies a cloud storage target for the data block F1. The deduplication unit 140 or another process of the gateway device 110 will also update another structure that maps block identifiers (e.g., UUIDs of data blocks) to location information. If a data block resides in the local storage 120 of the gateway device 110, then the location information may be a physical identifier and/or another logical identifier that another subsystem (e.g., flash storage subsystem) or process resolves to a physical location of the data block. Stage C2 represents the deduplication unit 140 updating the log 160 to indicate data blocks that have been written to the local storage 120. As depicted in FIG. 1, the deduplication unit 140 adds an entry into the log 120 that indicates the data block F1 and its tag “0.” The replication unit 180 uses the log 160 to track progress of replication of data blocks from the gateway device 110 to cloud storage.

For constituent data blocks of FILE2 that are duplicates, the shared data blocks will already be tagged and in the local storage 120. FIG. 1 depicts another data block 122 in local storage 120 that is also depicted as “F1.” Assuming file FILE_H in the namespace 112H includes a data block F1, the SLO 114H has caused the deduplication unit 140 to create the fingerprint index 142 for the namespace 112H. Since data of the namespace 112H is deduplicated with the fingerprint index 112H and the data of the namespaces 112A, 112B are deduplicated with the fingerprint index 141, the deduplication unit 140 writes two instances of the data block F1 into the local storage 120. The device 104 generates and assigns a different block identifier ID22 to the data block F1 of FILE_H. The isolation of the namespace 112H by the SLO 114H will persist into cloud storage by migrating data of the namespace 112H to a different cloud target than data of the namespaces 112A, 112B. Thus, the deduplication unit 140 tags these two instances with different cloud target indications, which results in the creation of the data blocks 121, 122 in the local storage 120. This also leads to the deduplication unit 140 creating an entry in the log 160 for block F1 to cloud target 0 and an entry in the log 160 for the block F1 to cloud target 1, but using their assigned identifiers ID7 and ID22.

As previously stated, files are written to the cloud storage gateway device 110 for migration into cloud storage. Stages D1-D3 represents a collection phase for migration of data from device 110 into cloud storage. The replication unit 180 is depicted as including a block reader 181 and a file metadata reader 183. Stage D1 represents the block reader 181 using the log 160 to identify data blocks to be migrated to cloud storage. Stage D2 represents the block reader 181 selecting the data blocks identified from Stage D1. This selection may be the block reader 181 reading the identified data blocks from storage into memory for replication to cloud storage by the replication unit 180. Stage D3 represents the file metadata reader 183 selecting file metadata blocks from the local storage 120 for migration to cloud storage. Although a log can also be maintained for file metadata blocks, the file metadata reader 183 can select file metadata blocks for migration without a log. The amount of file metadata blocks, in terms of either or both of size and number, to migrate is substantially less than the constituent data blocks. Therefore, the file metadata reader 183 can efficiently select file metadata blocks by timestamps, for example. For instance, the file metadata reader 183 can select for migration file metadata blocks older than a specified threshold age based on a creation timestamp of the file metadata block on the gateway device 110 (not the creation time of the file). When a data-migration trigger occurs, the block reader 181 reads the log 160 to determine a last migrated data block. FIG. 1 depicts the log 160 with a check symbol that represents a checkpoint written into the log 160 by the block reader 181 to mark progress. The block reader 181 resumes migrating from the checkpointed entry.

Stage E represents the replication unit 180 replicating data from the gateway device 110 to appropriate ones of cloud storage targets 195-196 based on a data migration triggering event. The replication unit 180 replicates data blocks selected by the block reader 181 and file metadata blocks selected by the file metadata reader 183. The replication unit 180 replicates the blocks according to the cloud storage targets indicated for the blocks by the tags. Data-migration triggering events may comprise one or more of the expiration of a retention period for a data file, the occurrence of an automatic data migration housekeeping phase, an explicit data-migration request of an administrative user, and/or the like.

FIG. 1 depicts the cloud storage target 195 as already hosting data blocks “S1” and “S3,” while the corresponding fingerprints I_{S1}, I_{S3} still remain in the fingerprint index 141. These entries for S1 and S3 can remain in the fingerprint index 141 because the SLO 114A allows for deduplication against data blocks that have already migrated off the gateway device 110 to cloud storage. This expands the storage efficiency of deduplication since data at the gateway device is deduplicated against data in cloud storage. An SLO, however, may limit deduplication to data blocks that have not yet been migrated for a namespace that a customer wishes to have cached at the gateway device for a specified period of time. Constraining the fingerprint index to cached data blocks avoids retrieving a data block from cloud storage in violation of the customer specification.

FIG. 1 only depicts of an example with a single SLO influencing deduplication for a namespace or namespaces. But a policy that governs a namespace may comprise multiple SLOs that influence deduplication. For instance, a policy for a namespace may indicate that cross-namespace deduplication is allowed but another SLO may indicate data is to be migrated to a cloud target in a particular jurisdiction. This results in a deduplication index being created and used for namespaces that are subject to these same SLOs. In other words, this combination of SLOs allows cross-namespace deduplication, but only with other namespaces that will migrate to the same cloud target.

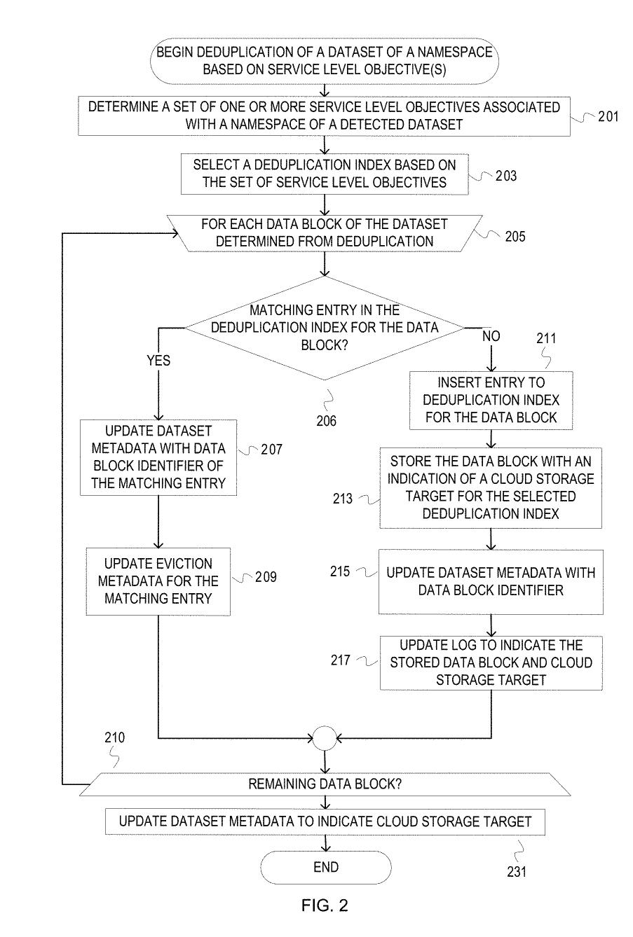

FIG. 2 provides a flowchart diagram illustrating example operations for deduplicating data received at a cloud storage gateway device against one or more of multiple deduplication indexes in accordance with one or more SLOs associated with a namespace of the dataset. The preceding figure referred to fingerprint indexes for the example illustrations. The following flowcharts refer to a deduplication index instead of a fingerprint index to more generically refer to an index used for deduplication that may not use a hash of a data block (e.g., byte matching). The following flowcharts also refer to datasets instead of files since deduplication is not limited to files. For instance, volumes can be deduplicated. The flowchart figures refer to a cloud storage gateway device or gateway device as performing the operation for consistency with FIG. 1. This naming consistency is for reading efficiency and should not impact claim scope.

At block 201, a cloud storage gateway device determines a set of one or more service level objectives associated with a namespace of a detected dataset. The cloud storage gateway device can detect a dataset for deduplication when the dataset is received, for example with in-line deduplication or as part of a background process if offline deduplication is performed. The cloud storage gateway device determines a namespace of the dataset with dataset metadata. The cloud storage gateway device then accesses a mapping of policies to namespaces or accesses a policy residing in a path defined for a policy of the namespace. For example, a policy file can be stored on the cloud storage gateway device in “ . . . /policies/research/data_policy/” for a research namespace. The policy comprises one or more service level objectives that influence deduplication of the dataset. Example deduplication influencing SLOs can be “cross-namespace deduplication allowed” and “low latency access of data in namespace.”

At block 203, the cloud storage gateway device selects a deduplication index based upon the determined set of SLOs. An SLO may specify a particular deduplication index, e.g., by a deduplication index identifier, etc. The cloud storage gateway device may resolve an SLO that indicates “low latency access” to a deduplication index created and maintained for backup data of a namespace to be maintained at the cloud storage gateway device for low latency access. The cloud storage gateway device may resolve an SLO to a criterion for selecting a deduplication index (e.g., an SLO expressed as security isolation” resolves to a criterion “namespace specific deduplication”). According to aspects of the disclosures, the SLO may specify that the deduplication index be physically or logically segregated within the gateway device (e.g., encrypted storage).

At block 205, the cloud storage gateway device begins performing operations for each data block of the dataset yielded from deduplication. FIG. 2 limits the illustration to operations related to updates made based on discovering duplicate and non-duplicate data blocks with respect to the associated SLO, and does not depict all of the deduplication operations for segmenting and comparisons that may be performed. The operations for segmenting and comparing for deduplication will vary depending up on the deduplication algorithm that is employed (e.g., fixed length or variable length deduplication, hash values as fingerprint, byte matching, etc.). So, the data blocks referred to in FIG. 2 do not include possible transient data blocks.

At block 206, the cloud storage gateway device determines whether the selected deduplication index has a matching entry for the data block. If no match is found, flow continues at block 211. If a match is found, control flows to block 207.

At block 207, the cloud storage gateway device updates the metadata associated with the dataset to indicate a data block identifier in the matching entry of the selected deduplication index. The block identifier can be considered a reference to the location of the data block, whether the block identifier directly or indirectly can be resolved to location information.

At block 209, the cloud storage gateway device updates eviction metadata for the matching entry. For example, the cloud storage gateway device increments a counter for the entry or refreshes a timestamp for the entry. The particular eviction metadata depends upon the eviction algorithm being used to maintain the deduplication indexes.

At block 210, the cloud storage gateway device determines whether there is an additional data block of the dataset. If there is an additional data block, flow continues back to block 205. If there are no additional data blocks of the dataset, then deduplication of the dataset has completed.

After deduplication of the dataset has completed, then the cloud storage gateway device updates metadata of the dataset to indicate the cloud storage target of the selected deduplication index at block 231. The cloud storage gateway device can associate a cloud storage target with a deduplication index in different manners. The cloud storage gateway device can maintain a mapping from deduplication indexes to cloud storage targets. The cloud storage gateway device can use an identifier of a cloud storage target (e.g., bucket name and/or account identifier).

If the cloud storage gateway device did not find a matching entry in the selected deduplication index, then the cloud storage gateway device inserts an entry to the deduplication index for the data block at block 211. For example, the cloud storage gateway device adds an entry or overwrites an entry with a fingerprint for the data block and an identifier of the data block. The determination that an entry is to be inserted can trigger an eviction evaluation.

At block 213, the cloud storage gateway device stores the data block with an indication of the cloud storage target into storage of the cloud storage gateway device. As discussed with respect to block 231, the cloud storage target corresponds to the selected deduplication index.

At block 215, the cloud storage gateway device updates the metadata associated with the dataset to indicate the identifier of the data block identifier. When the data block is generated from deduplication, the gateway device assigns an identifier to the data block. This identifier may be an identifier that represents block arrangement order that can be used when reconstructing the dataset. For example, the block identifier can be timestamp based, from a monotonically increasing generator, etc. As previously mentioned, the data block identifier resolves to location information (e.g., an object key in cloud storage or a logical address in storage of the gateway device).

At block 217, the cloud storage gateway device updates a log to indicate the stored data block and the cloud storage target. For example, the gateway device can update the log to indicate the block identifier for the stored data block and location information regarding where the data block was stored in local storage. The cloud storage gateway device can use the log to track progress of data block migration from the gateway device to cloud storage. Control flows from block 217 to block 210.

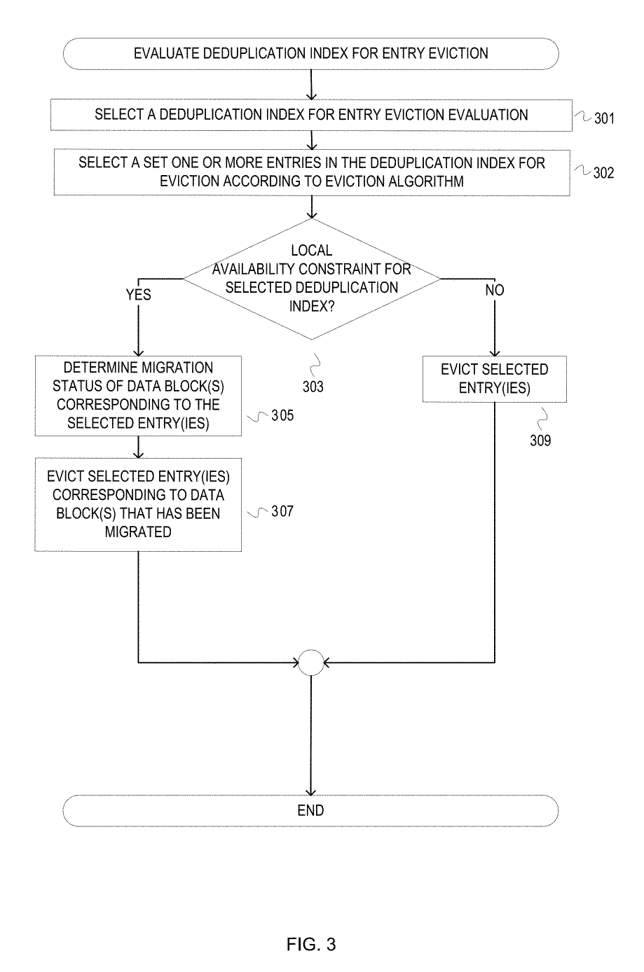

FIG. 3 provides a flowchart diagram illustrating example operations for evicting deduplication index entries. The example operations illustrated in FIG. 3 commence upon detection of an eviction evaluation trigger.

At block 301, the cloud storage gateway device selects a deduplication index for entry eviction evaluation. Selection of a deduplication index for entry eviction evaluation may be initiated in response to detection of an eviction evaluation trigger. Example of a trigger comprise one or more of: the expiration of a retention period for a dataset, size of a deduplication index exceeding a threshold, expiration of a defined time period, an on-demand trigger from an administrative user, etc. Selection of among multiple duplication indexes for entry eviction evaluation may be according to a defined order, according to prioritization of namespaces, etc. In addition, eviction can be performed concurrently across deduplication indexes.

At block 302, the cloud storage gateway device selects a set of one or more entries within the selected deduplication index to be evicted according to the eviction algorithm. The cloud storage gateway device may eviction metadata from each of the entries to select candidates for eviction. The cloud storage gateway device may traverse the deduplication index until a threshold number of entries have been selected for eviction.

At block 303, the cloud storage gateway device determines whether the selected deduplication index is subject to a local availability constraint. The cloud storage gateway device can access a policy associated with the deduplication index to determine whether the deduplication index is limited to representing data blocks that are available on storage of the cloud storage gateway device. If the deduplication index is subject to a local availability constraint, then control flows to block 305. Otherwise, control flows to block 309.

At block 305, the cloud storage gateway device determines migration status of the data block(s) corresponding to the selected set of one or more index entries. For instance, the gateway device accesses a log used to track progress of block migration. The gateway device searches the log for block identifiers corresponding to the selected index entries. The gateway device begins the search from a point marked in the log that indicates a last migrated data block. If a data block identifier is found that corresponds to a selected entry, then that data block has yet to be migrated.

At block 307, the cloud storage gateway device evicts the selected entry(s) that corresponds to a data block(s) that has been migrated into cloud storage. A selected entry that corresponds to a data block yet to be migrated remains in the deduplication index. This biases eviction towards migrated data blocks and effectively overrides the eviction algorithm in favor of data blocks that still remain in storage of the gateway device.

At block 309, the cloud storage gateway device evicts the selected set of one or more entries from the deduplication index. Since the deduplication index is not subject to a local availability constraint, migration status of the corresponding data blocks does not influence the eviction decision.

Variations

The above example illustrations described tagging both data blocks and file metadata blocks with indications of cloud storage targets (“migration target tag”). Tagging both the data blocks and the file metadata blocks with the migration target tags allows a multi-threaded approach to the migration. A thread can migrate data blocks to the appropriate cloud storage targets since the data blocks will be tagged with the appropriate migration target tag. However, a gateway device does not necessarily tag the data blocks and the file metadata blocks. The gateway device can tag a file metadata block, and determine the cloud storage target for constituent data blocks with the tag of the file metadata block.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 213, 215, and 217 can be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

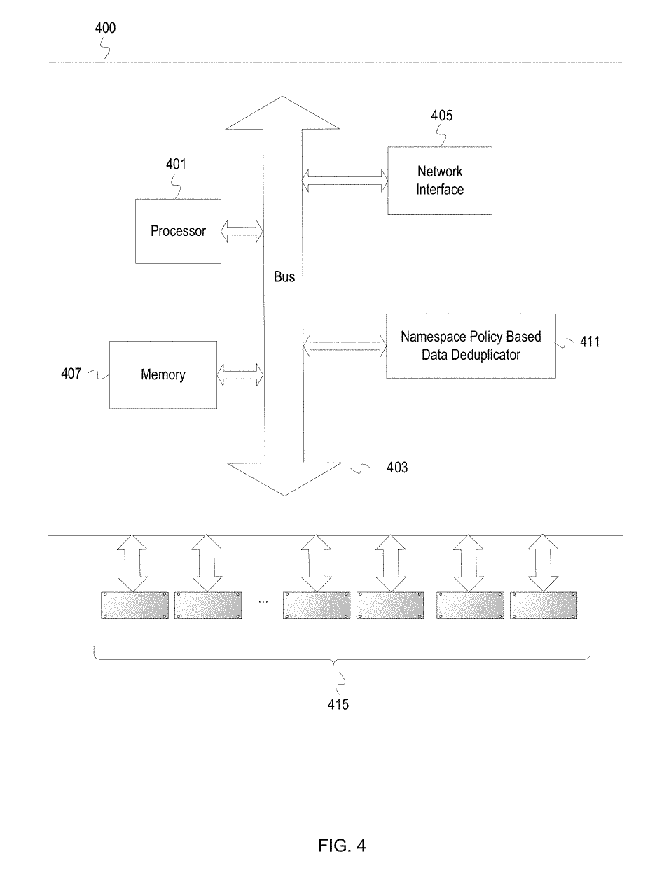

FIG. 4 depicts an example gateway device with a namespace policy based data deduplicator. A gateway device 400 includes a processor 401 (possibly including multiple processors, multiple cores, multiple nodes, and/or implementing multi-threading, etc.). The gateway device 400 includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The gateway device 400 also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The gateway device 400 also includes a namespace policy based data deduplicator 411. The namespace policy based data deduplicator 411 creates and maintains deduplication indexes for datasets of different namespaces subject to different service policies or services objectives that influence deduplication. The gateway device 400 is connected and may include a plurality of storage devices 415 in which datasets are stored prior to migration to cloud storage. Data within the storage devices 415 are available for low latency access by a dataset owner or gateway client. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the 401. The storage devices 415 may be in bays or docks of the gateway device 400. The storage devices 415 may be connected via a plurality of network interfaces (including the network interface 405) or other types of standardized hardware interfaces. The storage devices 415 may be solid state storage devices, magnetic storage devices, optical storage devices, or a combination of storage devices.

While the aspects of the disclosure are described with reference to various implementations and exploitations, it will be understood that these aspects are illustrative and that the scope of the claims is not limited to them. In general, techniques for data namespace policy driven deduplication as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. The term “cloud storage target” refers to an entity that has a network address that can be used as an endpoint for a network connection. The entity may be a physical device (e.g., a server) or may be a virtual entity (e.g., virtual server or virtual storage device). In more general terms, a cloud service provider resource accessible to customers is a resource owned/manage by the cloud service provider entity that is accessible via network connections. Often, the access is in accordance with an application programming interface or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
after receipt of a first dataset, determining a first service level objective associated with a first namespace corresponding to the first dataset;
selecting a first deduplication index from a plurality of deduplication indexes based, at least in part, on the service level objective; and
tagging metadata of the first dataset to indicate a cloud storage target corresponding to the first deduplication index.

2. The method of claim 1 further comprising, for a first data block of the first data set that does not have a matching entry in the first deduplication index, tagging the first data block to indicate the cloud storage target.

3. The method of claim 2 further comprising updating a log to indicate the first data block and the cloud storage target and storing the first data block in storage of a cloud storage gateway device that received the first dataset to back up to cloud storage.

4. The method of claim 1 further comprising receiving the first dataset to back up to the cloud storage target.

5. The method of claim 1, wherein tagging the metadata of the first dataset comprises updating a metadata block for the first dataset with an indication of the cloud storage target.

6. The method of claim 1 further comprising:
determining that the first service level objective indicates that data of the first namespace can be deduplicated with data of another namespace; and
determining that the first deduplication index is used to deduplicate data of namespaces to be migrated or already migrated to the cloud storage target.

7. The method of claim 1 further comprising determining a second service level object associated with the first namespace, wherein selection of the first deduplication index is also based on the second service level objective.

8. The method of claim 1 further comprising:
after receipt of a second dataset and after migration of a second data block of the first dataset to the cloud storage target, determining that a first data block of the second dataset is a duplicate of the second data block when deduplicating the second dataset with the first deduplication index.

9. The method of claim 8 further comprising updating metadata of the second dataset with an identifier of the second data block.

10. The method of claim 1 further comprising:
after detection of a migration trigger, reading data blocks of the first dataset from storage of a gateway device that received the first dataset;
for each of the data blocks of the first dataset,
determining that the data block is tagged with the indication of the cloud storage target;
migrating the data block to the cloud storage target based on the indication of the cloud storage target;
reading the metadata of the first dataset from the storage;
determining that the metadata is tagged with an indication of the cloud storage target; and
migrating the metadata of the first dataset to the cloud storage target based on the indication of the cloud storage target in the metadata.

11. The method of claim 1 further comprising:
after detection of an eviction related trigger, selecting one of the plurality of deduplication indexes;
determining a set of one or more entries of the selected deduplication index for eviction according to an eviction algorithm;
determining cloud migration status of each data block corresponding to the set of one or more entries; and
evicting those of the set of one or more entries corresponding to a data block that has been migrated to cloud storage.

12. One or more non-transitory machine-readable media comprising program code for namespace policy based deduplication, the program code to:
maintain a deduplication index for each of a plurality of cloud storage targets;
for deduplication of a dataset, select from the deduplication indexes based, at least in part, on a policy associated with a namespace of the dataset, wherein the policy comprises at least one service level objective that corresponds to at least one of the plurality of cloud storage targets; and
indicate, in metadata of the dataset the cloud storage target of the plurality of cloud storage targets that corresponds to the deduplication index selected to deduplicate the dataset.

13. The machine-readable storage media of claim 12, further comprising program code to deduplicate datasets of multiple namespaces with one of the deduplication indexes when the datasets are to be migrated to a same cloud storage target.

14. The machine-readable storage media of claim 12, further comprising program code to deduplicate datasets of multiple namespaces with one of the deduplication indexes when the multiple namespaces are governed by a same policy

15. The machine-readable media of claim 12, wherein the program code to maintain the deduplication indexes comprises allowing at least some entries to remain in deduplication indexes after corresponding data blocks have migrated to cloud storage targets.

16. The machine-readable media of claim 12, wherein the program code to maintain the deduplication indexes comprises allowing at least some entries to remain in deduplication indexes after corresponding data blocks have migrated to cloud storage targets.

17. The machine-readable media of claim 12 further comprising program code to:
after detection of an eviction related trigger, selecting one of the deduplication indexes;
apply an eviction algorithm to the selected deduplication index to determine a set of one or more entries of for eviction;
determine cloud migration status of each data block corresponding to the set of one or more entries; and
evict those of the set of one or more entries corresponding to a data block that has been migrated to cloud storage.

18. A storage gateway device comprising:
a processor; and
a machine-readable medium comprising program code executable by the processor to cause the storage gateway device to,
maintain a deduplication index for each of a plurality of cloud storage targets configured on the storage gateway device;
for deduplication of a dataset, select from the deduplication indexes based, at least in part, on a policy associated with a namespace of the dataset, wherein the policy comprises at least one service level objective that corresponds to at least one of the plurality of cloud storage targets; and
indicate, in metadata of the dataset the cloud storage target of the plurality of cloud storage targets that corresponds to the deduplication index selected to deduplicate the dataset.

19. The storage gateway device of claim 18, wherein the machine-readable medium further comprises program code to deduplicate datasets of multiple namespaces with one of the deduplication indexes when the datasets are to be migrated to a same cloud storage target.

20. The storage gateway device of claim 18, wherein the machine-readable medium further comprises program code to maintain the deduplication indexes comprises allowing at least some entries to remain in deduplication indexes after corresponding data blocks have migrated to cloud storage targets.
